(19) United States
(12) Patent Application Publication
(10) Pub. No.: US 2026/0355999 A1
(43) Pub. Date: Nov. 12, 2026

(54) Portable work apparatus

(71) Applicant: Andreas Stihl AG & Co. KG, Waiblingen (DE)

(72) Inventors: Pavel Kubicka, Krystofovy Hamry (CZ); Patrick Irmscher, Amtsberg (DE); Przemyslaw Zurek, Backnang (DE); Andreas Schulz, Erdmannhausen (DE); Sören Leinert, Pforzheim (DE); Tobias Spring, Gemmrigheim (DE); Thilo Stürzel, Remshalden (DE); Alexander Schindler, Steinheim an der Murr (DE); Alexander Lepold, Esslingen (DE); Johann-Sebastian Renz, Gomaringen (DE); Philipp Holz, Schwäbisch Gmünd (DE)

(73) Assignee: Andreas Stihl AG & Co. KG, Waiblingen (DE)

(21) Appl. No.: 19/670,109

(22) Filed: May 7, 2026

(30) Foreign Application Priority Data
May 9, 2025 (DE) 102025117999.9
May 9, 2025 (DE) 102025118001.6
May 9, 2025 (DE) 102025118003.2

(51) Int. Cl. B27B 17/02; B25F 5/00; B25F 5/02; B27B 17/00; B27B 17/08; B27B 17/14

(52) U.S. Cl. CPC B27B 17/02; B25F 5/008; B25F 5/02; B27B 17/0008; B27B 17/08; B27B 17/14

(57) ABSTRACT

A portable work apparatus has a housing, a guide bar, a saw chain, a fixing device, and a tensioning device with a pivotably mounted tensioning lever. In a released state of the fixing device, the guide bar is displaceable relative to the housing in the direction of a longitudinal center axis of the guide bar. In a fixed state of the fixing device, the guide bar is clamped to the housing. The tensioning lever is operatively connected to the guide bar so that pivoting the tensioning lever in a first pivoting direction moves the guide bar in the direction of the longitudinal center axis to tension the saw chain.

### CROSS-REFERENCE TO RELATED APPLICATION

This application claims the benefit of German Patent Applications DE 102025117999.9, filed on May 9, 2025; DE 102025118001.6, filed on May 9, 2025; and DE 102025118003.2, filed on May 9, 2025, the entire contents of which are incorporated by reference.

### TECHNICAL FIELD

The disclosure relates to a portable work apparatus.

### BACKGROUND

From the prior art, a portable work apparatus is known which comprises a housing, a drive motor arranged in the housing, a guide bar having a longitudinal center axis, and a saw chain. The drive motor, via a drive sprocket, drives the saw chain, which is guided in a guide groove of the guide bar, in circulation. Furthermore, the portable work apparatus comprises a fixing device for fastening the guide bar to the housing and a tensioning device for tensioning the saw chain. In a released state of the fixing device, the guide bar is displaceable relative to the housing in the direction of its longitudinal center axis. In a fixed state of the fixing device, the guide bar is clamped to the housing.

A disadvantage of such a portable work apparatus is that the tensioning device is of complex design and requires a large number of components.

### SUMMARY

It is an object of the disclosure to provide a portable work apparatus that has a simple yet equally functional tensioning device.

This object is achieved by a portable work apparatus comprising a housing, a drive motor arranged in the housing, a guide bar having a longitudinal center axis, and a saw chain, wherein the drive motor, via a drive sprocket, drives the saw chain, which is guided in a guide groove of the guide bar, in circulation, a fixing device for fastening the guide bar to the housing, and a tensioning device for tensioning the saw chain, wherein, in a released state of the fixing device, the guide bar is displaceable relative to the housing in the direction of its longitudinal center axis, and, in a fixed state of the fixing device, the guide bar is clamped to the housing. The tensioning device comprises a pivotably mounted tensioning lever, wherein the tensioning lever is operatively connected to the guide bar in such a way that, upon a pivoting movement of the tensioning lever in a first pivoting direction, the guide bar is movable by the tensioning lever in the direction of the longitudinal center axis of the guide bar for tensioning the saw chain. The tensioning device in particular acts directly on the guide bar.

The work apparatus is based on the finding that the tensioning device of the portable work apparatus known from the prior art comprises a gear train. The guide bar is not part of the gear train. This gear train converts a rotary movement, for example at an adjustment wheel, into a translational movement of a driver. This driver in turn engages in the guide bar and moves the guide bar, whereby the saw chain is tensioned.

In contrast, the tensioning device of the work apparatus according to the invention provides, instead of a conversion of types of movement, that the tensioning lever acts directly on the guide bar by a pivoting movement. Additional components for converting types of movement are not required. As a result, the tensioning device can be of simple design.

It is in particular provided that the tensioning device comprises a spring unit which biases the tensioning lever in the first pivoting direction. The spring unit is in particular formed as a leg spring. By using a spring unit, the tensioning lever is automatically preloaded. The operator does not have to preload the tensioning lever manually. The operator merely has to release the fixing device so that the clamping of the guide bar is cancelled. The tensioning lever then, under the preload of the spring unit, presses the guide bar forward, whereby the saw chain is tensioned. The resulting pretension of the saw chain is reproducible. Any action on the part of the operator during tensioning of the saw chain is not required. Operating errors are thus avoided.

It is in particular provided that the tensioning lever has a lever head which engages in an opening of the guide bar and is provided for contact with the guide bar. The guide bar is moved in particular via the lever head. The lever head in particular contacts the guide bar directly.

In particular, a chamfer is formed at the opening of the guide bar. During assembly of the guide bar, the guide bar is pivoted into its end position toward the housing. The tensioning lever engages in the opening of the guide bar, the guide bar thereby contacting the tensioning lever in such a way that the tensioning lever is pivoted by the guide bar in a second pivoting direction opposite to the first pivoting direction. By virtue of the chamfer at the opening of the guide bar, the guide bar and the tensioning lever contact one another with a surface angle which promotes sliding of the two components relative to one another. Instead of a chamfer, a radius may also be formed at the opening of the guide bar in an alternative embodiment. At the opening of the guide bar, the edge along the opening is formed with a broken edge in order to avoid self-locking during sliding between the tensioning lever and the guide bar. The breaking of the edge of the opening can be implemented by a chamfer, a radius or the like.

It is in particular provided that the tensioning lever has a lug which serves for fastening the tensioning lever to a retaining contour of the work apparatus. The tensioning lever projects out of the housing through a passage opening. Adjacent to the passage opening of the housing, the retaining contour of the work apparatus is formed. During assembly of the work apparatus, in particular during installation of the tensioning lever in the housing, the tensioning lever, under spring preload, engages against the retaining contour. By gripping around the retaining contour with the lug of the tensioning lever, the tensioning lever is fixed to the housing. This simplifies assembly.

It is in particular provided that the tensioning lever has a guide surface via which the tensioning lever contacts the guide bar for mounting the guide bar, wherein the guide surface is convexly curved. Owing to the convex curvature of the guide surface, mutual sliding of the guide surface and the guide bar is made possible independently of the pivot angle of the tensioning lever.

It is in particular provided that the guide surface of the tensioning lever is configured such that, when the guide bar is pivoted toward the tensioning lever, the tensioning lever is rotated by the guide bar in the second pivoting direction opposite to the first pivoting direction. During assembly of the guide bar, the saw chain is in particular placed around the guide bar and around the drive sprocket. In particular in this state, the guide bar is pivoted toward the housing. Before the guide bar lies flat against the housing, it comes into contact with the guide surface of the tensioning lever. The guide surface of the tensioning lever is configured in particular such that, when the guide bar, after first contact with the tensioning lever, is pressed further toward the housing, the tensioning lever is pivoted by the guide bar in the second pivoting direction. Pivoting of the tensioning lever in the second pivoting direction takes place in particular against the spring force of the spring unit. Pivoting of the tensioning lever in the second pivoting direction is effected solely by the contact forces between the guide bar and the tensioning lever. Additional manual action by the operator is not required. Assembly of the guide bar is therefore particularly simple.

It is in particular provided that the guide surface of the tensioning lever is shaped such that, at a contact point of the guide bar and the guide surface, an engagement angle between a tangential plane on the guide surface and a connecting line which intersects the pivot axis and the contact point is provided, wherein the engagement angle is at most 70°, in particular at most 60°, in particular approximately 56°. The smaller the engagement angle is, the lower is the tendency toward self-locking between the guide bar and the tensioning lever. The guide surface of the tensioning lever is configured such that the resulting engagement angle lies in a range that excludes self-locking of the contact pairing. The guide surface is formed, in a view in the direction of the pivot axis, in the form of a spiral, in particular a logarithmic spiral, about the pivot axis. As a result, the engagement angle is substantially constant over the entire guide surface of the tensioning lever. In the mounted position of the guide bar, the tensioning lever projects through the opening of the guide bar. The opening of the guide bar may be formed as an opening having a closed opening contour. Alternatively, the opening may also be formed as a slot.

It is in particular provided that the tensioning device, in a fully assembled state of the work apparatus, is enclosed by the housing, wherein the work apparatus in particular has a sprocket cover which is part of the housing, and wherein the tensioning lever of the tensioning device is accessible to the operator when the sprocket cover is removed. The tensioning device is in particular formed as an automatic tensioning device, i.e. when the operator releases the fixing device, the clamping effect of the fixing device on the guide bar is cancelled, whereby the tensioning device automatically moves the guide bar forward in the direction of the longitudinal center axis of the guide bar and tensions the saw chain. Thereafter, the guide bar is to be clamped again by way of the fixing device. If the sprocket cover is released, the operator can pivot the tensioning lever in the second pivoting direction against the spring force and remove the guide bar.

It is in particular provided that the spring unit of the tensioning lever is held on a boss of the tensioning lever, wherein in particular a first leg of the spring unit is held on the tensioning lever, in particular in a first groove of the tensioning lever, and wherein in particular a second leg of the spring unit is held on the housing, in particular in a second groove of the housing. This type of mounting of the spring unit allows a compact design with few components.

The present application further relates to a portable work apparatus.

From the prior art, portable work apparatuses are known, comprising a housing, a drive motor arranged in the housing, wherein the drive motor is provided for driving a tool of the work apparatus, wherein the housing comprises a housing main body, and wherein the housing comprises a cover for at least partially covering the housing main body. Such covers are usually formed as cover plates for covering a cooling-air inlet and/or a cooling-air outlet.

A disadvantage of the known work apparatuses is that the cover is provided merely for covering simply configured openings and/or fastening of the cover has proven to be cumbersome.

It is therefore an object to provide a portable work apparatus which permits a cover for geometries of greater complexity and at the same time can be fastened in a simple manner.

This object is achieved by a portable work apparatus of the generic type, wherein the work apparatus comprises a housing and a drive motor arranged in the housing, the drive motor being provided for driving a tool of the work apparatus. The housing comprises a housing main body and a cover for at least partially covering the housing main body. The cover is configured as a hood. By such a configuration of the cover, even more complex geometric forms of the basic housing can also be covered. The cover comprises a fastening contour which cooperates with a mating contour formed on the housing main body for a form-fitting connection between the cover and the housing main body. The cover is configured to be elastically deformable in order, during assembly of the work apparatus, to close the form-fitting connection between the fastening contour and the mating contour by means of a deformation of the cover.

For fastening the cover to the housing main body, the cover is deformed and thereby brought into an end position. In the end position, the fastening contour of the hood and the mating contour of the housing main body form a form-fitting connection. Consequently, for fastening the hood to the housing main body, the hood in particular merely has to be deformed and moved into its end position. This makes it possible to fasten the hood to the housing main body in a simple manner.

The housing main body may in particular consist of two housing parts, in particular of two housing halves. The cover may in particular be fastened to the housing main body after assembly of the two housing halves.

In the assembled state of the work apparatus, the cover is in particular undeformed. When the cover is in its end position, deformation of the cover is cancelled again and the form-fitting connection between the cover and the housing main body is established.

The cover can in particular be fastened to the housing main body without a tool. The deformation of the hood required for fastening can in particular be carried out manually without a tool. Simple assembly is possible.

It is in particular provided that the fastening contour of the cover is a retaining opening formed on the cover. The retaining opening has in particular a closed opening contour. This promotes the strength of the cover, in particular in the region of the opening contour.

The mating contour is in particular formed as a projection on the housing main body. The geometric configuration of the projection is in particular adapted to that of the opening contour. If the opening contour is formed, for example, as circular, the projection is advantageously likewise configured as circular. As a result, the projection and the opening contour in particular engage one another in a precisely fitting manner and form a form-fitting connection. In particular, the projection is formed only on one housing part, in particular on one housing half.

In an alternative embodiment, the opening contour may also be of open configuration, for example by a slot in the cover.

For fastening the cover on the housing main body, the cover is to be deformed in such a manner that the cover can in particular be at least partially slipped over the projection. Thereafter, the cover is to be positioned such that the projection engages into the retaining opening, or the projection and the retaining opening latch with one another. In this state, the cover is in particular in its end position, that is to say in a fastened position, and is undeformed. In the fastened state of the cover, the retaining opening of the cover in particular encloses the projection of the housing main body, whereby in particular the form-fitting connection between the cover and the housing main body is established. The retaining opening of the cover in particular completely encloses the projection of the housing main body. In other words, the projection of the housing main body extends at least partially, in particular completely, through the retaining opening of the cover.

It is in particular provided that the cover comprises at least one hinge element which is configured, during assembly of the work apparatus, to be supported on the housing main body and to pivot the cover toward the housing main body into a fastened position about an axis of rotation. For fastening the cover, the cover is in particular first placed against the housing main body with the hinge element, whereby the cover is pre-fixed on the housing main body. Thereafter, the cover is pivoted via the hinge element into its end position. The pre-fixing combined with pivoting-in of the cover allows simple fastening of the cover.

It is in particular provided that the work apparatus comprises a guide bar having a longitudinal center axis, on which a saw chain can be driven in circulation, and that a distance, measured in the direction of the longitudinal center axis, between the axis of rotation of the hinge element and the mating contour of the housing main body corresponds to at least 20% of an overall length of the housing measured in the direction of the longitudinal center axis. As the distance between the axis of rotation of the hinge element and the mating contour of the housing main body increases, the cover can be pivoted in more controllably.

It is in particular provided that at least one insertion element is formed on the cover, the insertion element engaging into the housing main body for fixing the cover. The insertion element is in particular formed as an insertion rib. The insertion element is configured such that it cooperates with the housing main body even before the cover reaches its end position and promotes targeted movement of the cover into its end position. Furthermore, the insertion element stabilizes the cover on the housing main body. A plurality of insertion elements may in particular also be provided on the cover.

It is in particular provided that an auxiliary pocket is formed on the housing main body, the auxiliary pocket serving for reaching beneath the cover. The auxiliary pocket is configured such that the operator can reach behind the cover via the auxiliary pocket when the cover is in its end position or in the state fastened to the housing main body. The operator can then deform the elastic cover in such a manner that the form-fitting connection between the fastening contour of the cover and the mating contour of the housing main body is released. Thereafter, the operator can pivot the cover away from the housing main body and remove it. In other words, the auxiliary pocket is configured such that the operator can engage behind the cover through the auxiliary pocket and then lever the cover off the housing main body by targeted deformation of the cover. The auxiliary pocket is in particular formed adjacent to the fastening contour of the cover. In this way, the cover can be levered away from the housing main body in a targeted manner at its fastening contour in order to release the form-fitting connection between the fastening contour of the cover and the mating contour of the housing main body.

It is in particular provided that the work apparatus comprises a tool cover and a fastening unit for fastening the tool cover, wherein the cover is secured via the fastening unit. The tool cover is in particular a bar cover. The fastening unit extends in particular through the fastening contour of the cover. Thus, no further openings in the cover are required for fastening the tool cover. By securing the cover by means of the fastening unit, the fastening unit has a dual function. In this way, the number of components can be reduced. In the present case, the fastening unit merely secures the cover, that is to say, during normal operation of the work apparatus, no transmission of force takes place between the fastening unit and the cover. The fastening unit can prevent lifting of the cover over the projection of the housing main body.

Further disclosure relates to another portable work apparatus.

From the prior art, a portable work apparatus is known, comprising a housing, a drive motor arranged in the housing, the drive motor being provided for driving a tool of the work apparatus, a control unit for controlling the drive motor, wherein the control unit comprises a control board having a front side and a rear side, a first cooling-air duct having a first cooling-air inlet formed on the housing for guiding a first cooling-air flow, and a second cooling-air duct having a second cooling-air inlet formed on the housing for guiding a second cooling-air flow.

The cooling-air flows are usually used for cooling the drive motor. A disadvantage of such a portable work apparatus is that it can nevertheless overheat. Functions of the work apparatus may be impaired in an overheated state.

The disclosure is therefore based on the object of providing a portable work apparatus that has efficient cooling.

This object is achieved by a portable work apparatus of the generic type, wherein the portable work apparatus comprises a housing, a drive motor arranged in the housing, the drive motor being provided for driving a tool of the work apparatus, a control unit for controlling the drive motor, wherein the control unit comprises a control board having a front side and a rear side, a first cooling-air duct having a first cooling-air inlet formed on the housing for guiding a first cooling-air flow, and a second cooling-air duct having a second cooling-air inlet formed on the housing for guiding a second cooling-air flow.

The rear side of the control board is part of an inner wall of the first cooling-air duct. The front side of the control board is part of an inner wall of the second cooling-air duct. The control board is arranged in the region of the first cooling-air inlet and the second cooling-air inlet in such a way that the rear side of the control board is directly impinged upon by the first cooling-air flow immediately after entry thereof into the first cooling-air duct, and that the front side of the control board is directly impinged upon by the second cooling-air flow immediately after entry thereof into the second cooling-air duct.

The disclosure is based on the finding that overheating of the work apparatus may result not only from heating of the drive motor, but also from heating of the control board. The portable work apparatus therefore has two cooling-air flows which are provided for cooling the control board. The first cooling-air flow is guided in such a way that it is provided for cooling the rear side of the control board. The second cooling-air flow is guided in such a way that it is provided for cooling the front side of the control board. Thus, the control board can be cooled efficiently during operation of the work apparatus, whereby overheating of the work apparatus can be avoided even under high loads.

It is in particular provided that a guide wall is provided which is provided for guiding the first cooling-air flow and the second cooling-air flow from the respective cooling-air inlets up to the control board. In this way, it is ensured that the cooling-air flows follow the predefined cooling-air paths along the control board and that the rear side and the front side of the control board are cooled with a correspondingly predefined volumetric flow of cooling air. Furthermore, in particular a comparatively small opening is provided on the guide wall, which may serve for pressure equalization between the cooling-air ducts. Such pressure equalization may be required in particular if one of the two cooling-air inlets is closed, for example, by the hand of the operator.

It is in particular provided that the control board is held on the guide wall. The control board is in particular held on the guide wall adjacent to the drive motor. Thus, the cooling-air flows can be guided to the drive motor in a simple manner. The cooling-air flows are initiated in particular by a fan wheel. The fan wheel is in particular driven by the drive motor. The fan wheel is in particular arranged in the drive motor. The closer the control board is arranged to the drive motor, the shorter the cooling-air ducts can be formed. As a result, the cooling air can be drawn in efficiently.

The first cooling-air inlet and the second cooling-air inlet are arranged adjacent to one another. A rear side of the guide wall forms part of the inner wall of the first cooling-air duct. A front side of the guide wall forms part of the inner wall of the second cooling-air duct.

It is in particular provided that the first cooling-air duct extends from the first cooling-air inlet over the rear side of the control board, over the front side of the control board, toward the drive motor. The first cooling-air duct extends in particular from the first cooling-air inlet over the rear side of the control board toward a rear end of the drive motor that faces the control board. Consequently, the first cooling-air flow flows in particular from the external environment of the work apparatus through the first cooling-air inlet into the interior of the housing of the work apparatus. The first cooling-air flow flows along the rear side of the control board and subsequently in particular flows at least partially along the front side of the control board. From the control board, the cooling-air flow flows toward the drive motor.

It is in particular provided that the control board extends from a first end facing the first cooling-air inlet and/or the second cooling-air inlet to a second end, wherein a first air-guiding element is arranged adjacent to the second end of the control board, said first air-guiding element being configured to deflect the first cooling-air flow from the rear side of the control board to the front side of the control board. The first air-guiding element is configured such that it guides the first cooling-air flow from the rear side of the control board to the front side of the control board with the lowest possible flow losses.

It is in particular provided that the second cooling-air duct extends from the second cooling-air inlet over the front side of the control board directly toward the drive motor. The second cooling-air duct extends in particular from the second cooling-air inlet over the front side of the control board directly toward a rear end of the drive motor that faces the control board. Consequently, the second cooling-air flow flows in particular from the external environment of the work apparatus through the second cooling-air inlet into the interior of the housing of the work apparatus. The second cooling-air flow flows in particular at least partially along the front side of the control board and then flows toward the drive motor.

It is in particular provided that at least one third cooling-air duct is provided for guiding a third cooling-air flow, wherein the at least one third cooling-air duct extends from a third cooling-air inlet to a front end of the drive motor that faces away from the control board. The third cooling-air flow serves in particular only for cooling the drive motor, i.e. the third cooling-air flow does not flow along the control board.

It is in particular provided that at least one outlet duct is provided for guiding the cooling-air flows out of the housing, wherein a part of the at least one outlet duct is a fourth partition wall which is configured to separate the cooling-air flows that have exited from the drive motor from the drive motor. This ensures that the cooling-air flows, after absorbing waste heat from a section of the drive motor or the control board, are guided away from and separated from the drive motor in such a way that heat accumulation in the region of the drive motor is avoided.

It is in particular provided that the first cooling-air duct and the second cooling-air duct extend at least partially substantially parallel to the control board. Thus, efficient heat dissipation from the control board to the first cooling-air flow and to the second cooling-air flow can be ensured.

Further features of the invention are apparent from the description and the drawing, in which an embodiment of the invention described in detail below is illustrated.

### BRIEF DESCRIPTION OF THE DRAWINGS

FIG. 1 is a perspective view of an embodiment of the portable work apparatus,

FIG. 2 is a side view of the portable work apparatus according to FIG. 1 in a viewing direction toward a first longitudinal side of the housing,

FIG. 3 is a side view of the portable work apparatus according to FIG. 1 in a viewing direction toward a second longitudinal side of the housing,

FIG. 4 is a perspective rear view of the portable work apparatus according to FIG. 1,

FIG. 5 is a side view of the portable work apparatus according to FIG. 1 with the housing open,

FIG. 6 is a fragmentary side view of a region of the open housing with the control board and the drive motor of the portable work apparatus according to FIG. 1,

FIG. 7 is a side view of the portable work apparatus according to FIG. 1 in a viewing direction toward the first longitudinal side of the housing with the sprocket cover removed,

FIG. 8 is a perspective exploded view of the portable work apparatus according to FIG. 1,

FIG. 9 is a partial sectional plan view of the portable work apparatus according to FIG. 1 during mounting of the guide bar,

FIG. 10 is a fragmentary sectional plan view of the portable work apparatus according to FIG. 1 during pivoting-in of the guide bar,

FIG. 11 is a fragmentary sectional plan view of the portable work apparatus according to FIG. 1 with the guide bar pivoted in,

FIG. 12 is a side view of the portable work apparatus according to FIG. 1 without a guide bar,

FIG. 13 is a perspective view of the hood-shaped cover of the portable work apparatus according to FIG. 1,

FIG. 14 is a side view of the portable work apparatus according to FIG. 1 during pivoting-in of the hood-shaped cover,

FIG. 15 is a side view of the portable work apparatus according to FIG. 1 without a cover,

FIG. 16 is a fragmentary sectional view of the hood-shaped cover during mounting on the housing main body of the portable work apparatus according to FIG. 1,

FIG. 17 is a fragmentary sectional view of the hood-shaped cover in a mounted and fixed state on the housing main body of the portable work apparatus according to FIG. 1, and

FIG. 18 is a schematic side view of the guide bar of the work apparatus.

### DETAILED DESCRIPTION

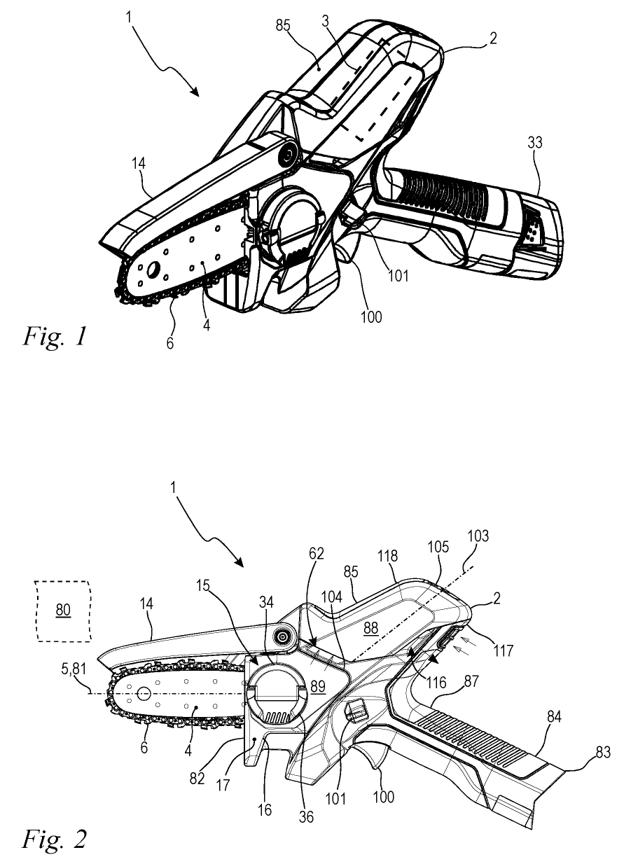

In FIG. 1, an embodiment of a work apparatus 1 is shown. The portable, in particular hand-held work apparatus 1 is configured in the exemplary embodiment as a shrub cutter. A shrub cutter is a motor-driven work apparatus which is provided in particular for cutting branches and small wood. A preferred use of a shrub cutter is in particular delimbing trees. The work apparatus 1 may in an alternative embodiment also be configured as a chain saw or the like. In addition, the work apparatus 1 may also be configured as a work apparatus with a shaft, for example as a pole pruner or the like. The term "portable" is to be understood such that the work apparatus is carried by the operator during intended operation.

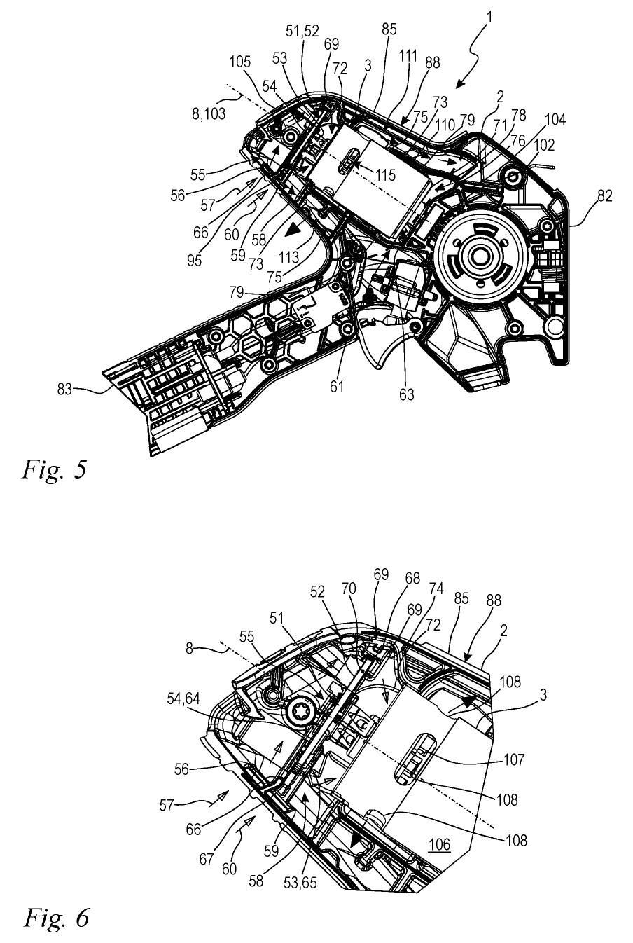

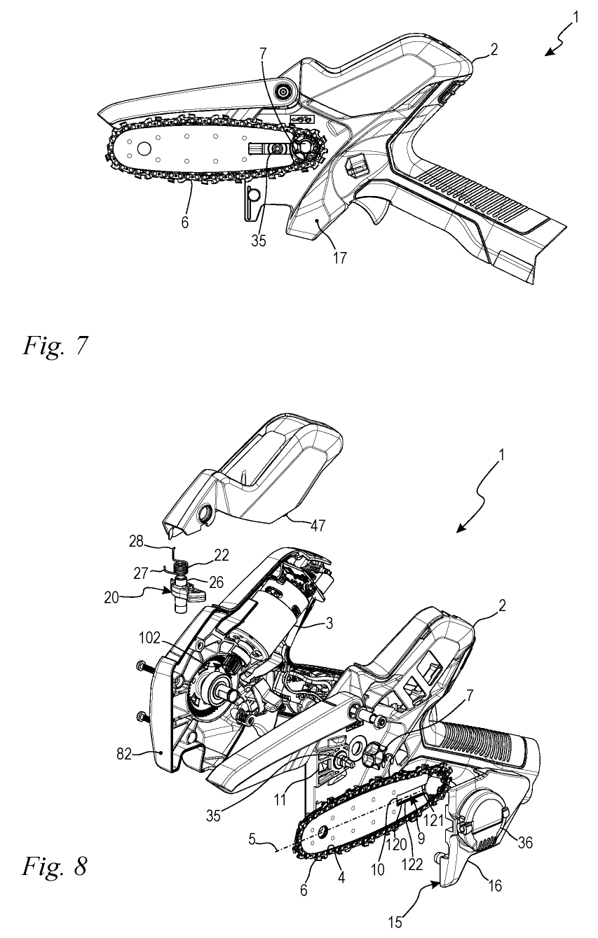

The work apparatus 1 comprises a housing 2. The work apparatus 1 comprises a drive motor 3. In FIG. 1, the drive motor 3 is shown merely schematically by a dashed line. The drive motor 3 is arranged in the housing 2, as is shown, for example, also in FIGS. 5, 6, and 8. Furthermore, the work apparatus 1 comprises a tool 6, the tool 6 being driven by the drive motor 3. In the present exemplary embodiment, the tool 6 is a saw chain. The saw chain is driven in circulation in a guide groove of a guide bar 4. The drive motor 3, via its drive shaft, drives a drive sprocket 7 (FIGS. 7 and 8), which in turn drives the saw chain 6 in circulation around the guide bar 4. A pivotable tool cover 14 is arranged in particular on the housing 2. The tool cover 14 overlaps the upper side of the guide bar 4 and thus also the tool 6. When sawing with the incoming chain through the material being cut, the tool cover 14 pivots upward. The side of the guide bar 4 at which the saw chain 6 runs into the housing 2 is the underside of the guide bar 4. The side of the guide bar 4 at which the saw chain 6 runs out of the housing 2 is the upper side of the guide bar 4. Terms such as "top/above" and "bottom/below" refer to the orientation of the upper side and the underside of the guide bar 4.

The drive motor 3 is configured as an electric motor in the exemplary embodiment. As shown in FIG. 1, the work apparatus 1 comprises at least one battery pack 33 for supplying the drive motor 3 with electrical energy. In an alternative, not further illustrated embodiment of the work apparatus 1, the work apparatus 1 comprises a further battery pack which is likewise provided for supplying the drive motor 3 with electrical energy. In an alternative configuration of the work apparatus 1, the drive motor 3 may also be configured as an internal combustion engine.

As shown in FIG. 2, the guide bar 4 comprises a longitudinal center axis 5. Furthermore, the work apparatus 1 comprises a longitudinal plane 80 which is spanned by the guide groove of the guide bar 4. The longitudinal center axis 5 of the guide bar 4 lies in the longitudinal plane 80. The longitudinal center axis 5 passes centrally through the guide bar 4, whereby, in a view perpendicular to the longitudinal plane 80 of the guide bar 4, the guide bar 4 is divided by the longitudinal center axis 5 into approximately two equal-sized parts. Furthermore, the guide bar 4 comprises a transverse plane 81. The transverse plane 81 is oriented orthogonally to the longitudinal plane 80 of the guide bar 4. The longitudinal center axis 5 lies in the transverse plane 81.

As shown in FIG. 2, the housing 2 of the work apparatus 1 comprises a front end 82 and a rear end 83. The guide bar 4 is fastened to the housing 2 and projects out of the housing 2 at the front end 82 of the housing 2. The rear end 83 of the housing 2 is formed in the present embodiment by a first handle 84, in particular by a receiving section 86 formed on the first handle 84. The battery pack 33 is held on the receiving section 86. The battery pack 33 is releasably held in the receiving section 86. In an alternative embodiment, the receiving section 86 may also be provided at another location of the work apparatus 1.

As shown in FIGS. 1 and 2, the work apparatus 1 comprises the first handle 84 for supporting a hand of the operator. The first handle 84 is formed on a handle housing 87. The handle housing 87 is part of the housing 2. The work apparatus 1 comprises an actuating element 100 for actuating the drive motor 3. The actuating element 100 is associated with the first handle 84, i.e. in intended operation of the work apparatus 1, the operator actuates the actuating element 100 with the hand that rests on the first handle 84. The first handle 84 is configured in particular as an operating handle. The actuating element 100 is configured in particular as a control lever. The first handle 84 is preferably configured such that it can be enclosed by the operator with one hand. As a result, the operator can hold, in particular carry, the work apparatus 1 at the first handle 84.

As shown in FIGS. 1 and 2, the work apparatus 1 comprises a locking element 101, the locking element 101 being configured in particular as a mechanical locking element 101. The locking element 101 is preferably configured as a locking lever. The locking element 101 is configured to lock the actuating element 100 in a locking position, in particular mechanically, and to release it in an operating position. If the operator wishes to actuate the actuating element 100, the operator must first unlock the actuating element 100 by actuating the locking element 101. The operator can then actuate the actuating element 100 and drive the drive motor 3.

The work apparatus 1 comprises, in addition to the first handle 84, a second handle 85. The second handle 85 serves to support the second hand of the operator and enables the operator to guide the work apparatus 1 in an improved manner. The second handle 85 is provided on the housing 2, in particular in the region of the drive motor 3.

As shown in FIG. 2, the work apparatus 1 comprises a fixing device 15 for fastening the guide bar 4. In a fixed state of the fixing device 15, the guide bar 4 is clamped to the housing 2. In a released state of the fixing device 15, the guide bar 4 is displaceable relative to the housing 2 in the direction of the longitudinal center axis 5. The guide bar 4 can be pushed away from the housing 2 in the direction of its longitudinal center axis 5, whereby the saw chain 6 can be tensioned.

As shown in FIG. 2, the work apparatus 1 comprises a sprocket cover 16. The sprocket cover 16 is part of the fixing device 15. In the fixed state of the fixing device 15, the guide bar 4 is clamped between the sprocket cover 16 and the housing 2. For fastening the sprocket cover 16 to the housing 2, a nut 34 is provided. The nut 34 is to be screwed onto a stud 35 (FIGS. 7 and 8) which is fixedly connected to the housing 2. In this case, by way of the nut 34, the sprocket cover 16 is pressed against the guide bar 4 and the guide bar 4 against the housing 2. The nut 34 comprises a pivotable lever 36, which, in an upright position, serves for turning the nut 34. Thus, the nut 34 can be tightened and loosened by the operator without tools. The sprocket cover 16 of course covers the drive sprocket 7 driven by the drive motor 3.

As shown in FIGS. 5 and 6, the portable work apparatus 1 comprises a control unit 51. The control unit 51 is configured in particular for controlling the drive motor 3. The control unit 51 may also be provided for carrying out further functions of the work apparatus 1. The control unit 51 comprises a control board 52. The control board 52 is arranged in particular in the housing 2. The control board 52 is arranged in particular in a motor section 88 of the housing 2, in which the drive motor 3 is also arranged. In the present embodiment, this motor section 88 also forms the second handle 85 of the work apparatus 1.

As shown in FIG. 6, the control board 52 comprises in particular a front side 53 and a rear side 54. The control board 52 and the drive motor 3 are arranged relative to one another in such a way that the front side 53 of the control board 52 is oriented in particular toward the drive motor 3 and that the rear side 54 of the control board 52 is oriented in particular away from the drive motor 3. The drive motor 3 comprises a rotational axis 8. The control board 52 is arranged in particular relative to the drive motor 3 in such a way that the front side 53 and the rear side 54 of the control board 52 are oriented approximately perpendicular to the rotational axis 8 of the drive motor 3. The control board 52 and the drive motor 3 are aligned relative to one another in such a way that the rotational axis 8 of the drive motor 3 intersects the control board 52. Electrical and/or electronic components are fastened in particular on the control board 52.

As shown in FIGS. 5 and 6, the portable work apparatus 1 comprises in particular a first cooling-air duct 55 and a second cooling-air duct 58. The first cooling-air duct 55 is configured in particular for guiding a first cooling-air flow 57. The second cooling-air duct 58 is configured in particular for guiding a second cooling-air flow 60. The first cooling-air flow 57 and the second cooling-air flow 60 serve at least for cooling the control board 52, in particular for cooling the components fastened to the control board 52.

The first cooling-air duct 55 comprises in particular a first cooling-air inlet 56. The first cooling-air inlet 56 is formed on the housing 2. Cooling air passes from the external environment of the work apparatus 1 into the first cooling-air duct 55 via the first cooling-air inlet 56. The first cooling-air duct 55 has an inner wall 64. The rear side 54 of the control board 52 is a part of the inner wall 64 of the first cooling-air duct 55. The first cooling-air flow 57 flowing along the inner wall 64 thus cools the control board 52 on its rear side 54.

As shown in FIGS. 5 and 6, the first cooling-air duct 55 extends from the first cooling-air inlet 56 along the rear side 54 of the control board 52. Furthermore, the portable work apparatus 1 comprises in particular a first air-guiding element 69. The first air-guiding element 69 is part of the first cooling-air duct 55. The first air-guiding element 69 is formed and arranged in such a way that it deflects the first cooling-air flow 57 from the rear side 54 of the control board 52 to the front side 53 of the control board 52. The first air-guiding element 69 is formed in such a way that flow losses during transfer of the first cooling-air flow 57 from the rear side 54 to the front side 53 of the control board 52 are as low as possible. The first cooling-air duct 55 further extends from the first air-guiding element 69 along the front side 53 of the control board 52. Starting from the front side 53 of the control board 52, the first cooling-air duct 55 extends as far as the drive motor 3.

As shown in FIG. 6, the control board 52 is held in the housing 2. Like conventional boards, the control board 52 is formed as a planar element. In addition to the front side 53 and the rear side 54, the control board 52 has a circumferential edge 70, via which the front side 53 and the rear side 54 are connected to one another. The control board 52 is preferably fastened to the housing 2 near its circumferential edge 70.

As shown in FIG. 6, the control board 52 extends from a first end 67 to a second end 68. In the present exemplary embodiment, the first end 67 of the control board 52 is oriented toward the first cooling-air inlet 56. Furthermore, in the present exemplary embodiment, the first end 67 of the control board 52 is oriented toward the second cooling-air inlet 59. The second end 68 of the control board 52 faces away from the first cooling-air inlet 56 and/or the second cooling-air inlet 59. The second end 68 of the control board 52 is oriented toward the air-guiding element 69. The air-guiding element 69 is arranged at a distance from the second end 68 of the control board 52, in particular from the edge 70 of the control board 52 in the region of the second end 68 of the control board 52, whereby the first cooling-air flow 57 can flow between the second end 68 and the air-guiding element 69. In relation to the direction of the rotational axis 8 of the drive motor 3, the first air-guiding element 69 overlaps the control board 52, in particular the edge 70 of the control board 52 in the region of the second end 68 of the control board 52, whereby the first cooling-air flow 57 is guided by the first air-guiding element 69 from the rear side 54 of the control board 52 to the front side 53 of the control board 52.

As shown in FIG. 6, the air-guiding element 69 comprises in particular only rounded surfaces. The air-guiding element 69 is free from edges in order to reduce flow separation or similar flow losses. The air-guiding element 69 has a flow surface 74 oriented toward the second end 68 of the control board 52, the flow surface 74 of the first air-guiding element 69 being formed convexly with respect to the second end 68 of the control board 52. The convex configuration of the first air-guiding element 69 brings about a curved guidance of the first cooling-air flow 57 along the first air-guiding element 69.

The second cooling-air duct 58 comprises in particular a second cooling-air inlet 59. The second cooling-air inlet 59 is formed on the housing 2. Cooling air passes from the external environment of the work apparatus 1 into the second cooling-air duct 58 via the second cooling-air inlet 59. The second cooling-air duct 58 has an inner wall 65. The front side 53 of the control board 52 is a part of the inner wall 65 of the second cooling-air duct 58. The second cooling-air flow 60 flowing along the inner wall 65 thus cools the control board 52 on its front side 53.

The control board 52 forms both a part of the inner wall 64 of the first cooling-air duct 55 and a part of the inner wall 65 of the second cooling-air duct 58. Thus, the control board 52 is cooled on its front side 53 and on its rear side 54 by two separate cooling-air flows 57, 60, whereby efficient removal of heat from the control board 52 and thus efficient cooling of the control board 52 is ensured. Since the control board 52 forms, at least in part, an inner wall 64, 65 for both the first cooling-air duct 55 and the second cooling-air duct 58, the first cooling-air duct 55 and the second cooling-air duct 58 run at least partially parallel to one another.

As shown in FIGS. 5 and 6, the second cooling-air duct 58 extends from the second cooling-air inlet 59 along the front side 53 of the control board 52. The second cooling-air duct 58 further extends from the front side 53 of the control board 52 toward the drive motor 3.

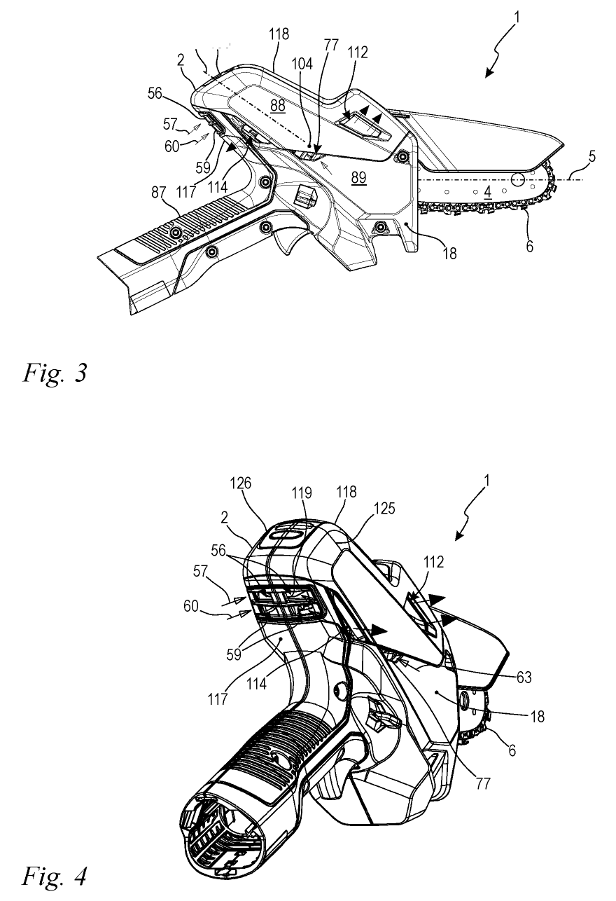

As shown in FIGS. 2 and 3, the housing 2 comprises a central section 89. The housing 2 thus comprises a central section 89, a handle housing 87, and a motor section 88. A gear train 102 is arranged in the central section 89 of the housing 2 (FIG. 8). The gear train 102 serves for transmission of speed and torque from the drive motor 3 to the drive sprocket 7. The drive motor 3 is arranged in the motor section 88 of the housing 2. The motor section 88 extends along its longitudinal center axis 103 from a front end 104 thereof to a rear end 105 thereof. The front end 104 of the motor section 88 opens into the central section 89 of the housing 2. The rear end 105 is a free end. The rear end 105 of the motor section 88 lies above the longitudinal center axis 5 of the guide bar 4.

As shown in FIG. 5, the drive motor 3 is arranged in the motor section 88 of the housing 2. In a view in the longitudinal plane 80 of the work apparatus 1, the rotational axis 8 of the drive motor 3 encloses with the longitudinal center axis 103 of the motor section 88, or with a line parallel to the longitudinal center axis 103, an angle which is less than 30°, in particular less than 20°, in particular less than 10°. In the preferred exemplary embodiment, the direction of the rotational axis 8 of the drive motor 3 is oriented approximately parallel to the direction of the longitudinal center axis 103.

As shown in FIG. 5, the drive motor 3 extends along its rotational axis 8 from a front end 71 thereof to a rear end 72 thereof. The rear end 72 of the drive motor 3 is oriented toward the free, rear end 105 of the motor section 88 of the housing 2. The front end 71 of the drive motor 3 is oriented toward the front end 104 of the motor section 88 of the housing 2. The control board 52 is arranged in particular between the rear end 72 of the drive motor 3 and the free, rear end 105 of the motor section 88 of the housing 2. The front side 53 of the control board 52 is oriented in particular toward the rear end 72 of the drive motor 3. The rear side 54 of the control board 52 is oriented in particular toward the rear end 105 of the motor section 88 of the housing 2.

As shown in particular in FIG. 6, the first cooling-air flow 57 and the second cooling-air flow 60 flow, starting from the front side 53 of the control board 52, via the rear end 72 of the drive motor 3 into the drive motor 3. The drive motor 3 comprises a motor housing 106. Via the motor housing 106, the drive motor 3 is held on the housing 2 of the work apparatus 1. A stator and a rotor of the drive motor 3, which are not illustrated in detail, are arranged in the motor housing 106 of the drive motor 3 and fastened to the motor housing 106 or mounted with respect to the motor housing 106. Furthermore, the drive motor 3 comprises a fan wheel 107. The fan wheel 107 is connected in particular to the rotor of the drive motor 3. During operation of the drive motor 3, the fan wheel 107 also rotates about the rotational axis 8 of the drive motor 3, whereby air is drawn in. The first cooling-air flow 57 and the second cooling-air flow 60 are induced. The cooling air for the drive motor 3 can flow into the motor housing 106 of the drive motor 3 through openings which are not illustrated in detail at the rear end 72 of the drive motor 3, in particular of the motor housing 106. Furthermore, a plurality of outlets 108 are provided on the motor housing 106, in particular on the circumferential side of the motor housing 106, through which the cooling air drawn in via the fan wheel 107 is blown out of the motor housing 106.

As shown in FIG. 6, the work apparatus 1 comprises a guide wall 66. The guide wall 66 is formed in such a way that it at least partially separates the first cooling-air duct 55 and the second cooling-air duct 58 from one another. The guide wall 66 is provided for guiding the first cooling-air flow 57 and the second cooling-air flow 60, starting from the respective cooling-air inlets 56, 59, as far as the control board 52. By the guide wall 66, the cooling-air flows 57, 60 are guided substantially independently of one another to the control board 52. Flow-through of the cooling-air flows 57, 60 into one another is not intended in intended operation of the work apparatus 1.

Furthermore, a, in particular comparatively small, opening 95, which is not illustrated in detail, may be provided on the guide wall 66 and may serve for pressure equalization between the cooling-air ducts 55, 58. Such pressure equalization may be required in particular when one of the two cooling-air inlets 56, 59 is closed, for example by the hand of the operator. The guide wall 66 is formed in such a way that it separates the first cooling-air duct 55 and the second cooling-air duct 58, starting from their respective cooling-air inlets 56, 59, at least as far as the control board 52 substantially spatially from one another.

The guide wall 66 comprises in particular at least two holding ribs between which the control board 52 is held. One holding rib of the guide wall 66 bears against the rear side 54 of the control board 52. The other holding rib of the guide wall 66 bears against the front side 53 of the control board 52. The opening 95 in the guide wall 66 for pressure equalization between the first cooling-air duct 55 and the second cooling-air duct 58 may, for example, be formed by subdivision of each of the at least two holding ribs into two further holding ribs spaced apart from one another. In such an embodiment, the opening 95 of the guide wall 66 is formed as a gap, in particular between the two housing halves 125, 126. Other configurations may also be expedient.

As shown in FIGS. 4 and 6, the first cooling-air inlet 56 and the second cooling-air inlet 59 are arranged adjacent to one another. As shown in particular in FIG. 4, the housing 2 comprises a first housing half 125 and a second housing half 126, which are separated by a plane oriented parallel to the longitudinal plane 80. Both the first cooling-air inlet 56 and the second cooling-air inlet 59 are interrupted by an in particular common stiffening rib 119. The stiffening rib 119 extends along the separating plane of the two housing halves 125, 126. The first cooling-air inlet 56 extends in particular over both housing halves 125, 126. The second cooling-air inlet 59 extends in particular over both housing halves 125, 126. On both housing halves 125, 126, the first cooling-air inlet 56 and the second cooling-air inlet 59 are arranged adjacent to one another. The first cooling-air inlet 56 is arranged in particular above the second cooling-air inlet 59. The first cooling-air inlet 56 and the second cooling-air inlet 59 are separated spatially from one another in particular only by the guide wall 66. The first cooling-air inlet 56 and the second cooling-air inlet 59 bear in particular against opposite sides of the guide wall 66. The guide wall 66 extends from the first cooling-air inlet 56 and/or the second cooling-air inlet 59 to the control board 52, in particular at least as far as the first end 67 of the control board 52. By means of the guide wall 66, targeted supply of a minimum volumetric flow of cooling air to the front side 53 and to the rear side 54 of the control board 52 can be ensured.

As shown in FIG. 5, the control board 52 is arranged in the region of the first cooling-air inlet 56 and the second cooling-air inlet 59. The term "in the region" is to be understood here such that no components are arranged between the cooling-air inlets 56, 59 and the control board 52 which bring about a significant heat input into the cooling-air flows 57, 60. The control board 52 is arranged in the region of the first cooling-air inlet 56 and the second cooling-air inlet 59 in such a way that the rear side 54 of the control board 52 is impinged upon by the first cooling-air flow 57 immediately after the latter flows into the first cooling-air duct 55 and that the front side 53 of the control board 52 is impinged upon by the second cooling-air flow 60 immediately after the latter flows into the second cooling-air duct 58. The control board 52 is held on the guide wall 66. The control board 52 is arranged in particular adjacent to the drive motor 3, in particular adjacent to the rear end 72 of the drive motor 3. The distance between the control board 52 and the drive motor 3 is less than the diameter of the drive motor 3, in particular less than half the diameter of the drive motor 3. Due to a small distance between the drive motor 3 and the control board 52, the cooling-air ducts 55, 58 are formed as short as possible, whereby the flow resistances are also low.

As shown in FIG. 5, the work apparatus 1 may comprise at least one third cooling-air duct 61 for guiding a third cooling-air flow 63. A third cooling-air inlet 62 is formed on the housing 2 (FIG. 2). Air can flow from the external environment of the work apparatus 1 into the third cooling-air duct 61 via the third cooling-air inlet 62. The third cooling-air duct 61 extends from the third cooling-air inlet 62 toward the front end 71 of the drive motor 3. The motor housing 106 of the drive motor 3 has, at the front end 71, openings which are not illustrated in detail, through which the third cooling-air flow 63 can flow into the drive motor 3, in particular into the motor housing 106 of the drive motor 3. Thus, the third cooling-air duct 61 extends into the drive motor 3 as far as the fan wheel 107. The third cooling-air flow 63 flows through the drive motor 3, in particular through the windings of the drive motor 3 which are not illustrated in detail, whereby the heat generated in the drive motor 3 can be dissipated. Starting from the fan wheel 107, the cooling air drawn in is blown out of the motor housing 106.

As shown in FIG. 5, the work apparatus 1 comprises at least one fourth cooling-air duct 76 for guiding a fourth cooling-air flow 78. A fourth cooling-air inlet 77 is formed on the housing 2 (FIG. 3). Air can flow from the external environment of the work apparatus 1 into the fourth cooling-air duct 76 via the fourth cooling-air inlet 77. The fourth cooling-air duct 76 extends from the fourth cooling-air inlet 77 toward the front end 71 of the drive motor 3. From there, the fourth cooling-air duct 76 extends as far as the fan wheel 107. The fourth cooling-air flow 78 flows through the drive motor 3, in particular through the windings of the drive motor 3 which are not illustrated in detail, whereby the heat generated in the drive motor 3 can be dissipated. Starting from the fan wheel 107, the cooling air drawn in is blown out of the motor housing 106.

As shown in FIG. 5, all cooling-air ducts 55, 58, 61, 76 extend from their respective cooling-air inlets 56, 59, 62, 77 in particular as far as the fan wheel 107. All cooling-air flows 57, 60, 63, 78 are blown out of the motor housing 106 via the fan wheel 107.

As shown in FIG. 5, the work apparatus 1 comprises at least one outlet duct 111, 113, 115, in particular a plurality of outlet ducts 111, 113, 115, in particular three outlet ducts 111, 113, 115, for guiding the cooling-air flows out of the housing 2 of the work apparatus 1. The at least one outlet duct 111, 113, 115 extends from the motor housing 106, in particular from an opening on the circumferential side of the motor housing 106, to an outlet 112, 114, 116 (FIGS. 2 and 4). The outlet 112, 114, 116 is formed as an opening in the housing 2 of the work apparatus 1, which permits the cooling-air flows 57, 60, 63, 78 to flow out of the housing 2 into the external environment of the work apparatus 1. A respective outlet 112, 114, 116 of the housing 2 is assigned to each outlet duct 111, 113, 115.

As shown in FIG. 5, the work apparatus 1 comprises a plurality of partition walls 73, 75, 79, 110. The partition walls 73, 75, 79, 110 are formed in particular such that the cooling-air flows 57, 60, 63, 78 do not intersect at least locally. Furthermore, the partition walls 73, 75, 79, 110 are formed in particular such that the first cooling-air flow 57 and the second cooling-air flow 60 do not intersect with the third cooling-air flow 63 and the fourth cooling-air flow 78. The control board 52 is fastened in particular to the guide wall 66. The control board 52 sits in a groove which is formed at least partially by the guide wall 66.

A first partition wall 73 is arranged on the circumferential side of the motor housing 106. The first partition wall 73 is arranged in the region of the rear end 72 of the drive motor 3 and extends radially with respect to the rotational axis 8 of the drive motor 3. With respect to the direction of the rotational axis 8 of the drive motor 3, the first partition wall 73 is arranged between the rear end 72 of the drive motor 3 and the fan wheel 107. The first partition wall 73 is formed in such a way that the first cooling-air flow 57 and the second cooling-air flow 60 flow into the motor housing 106 directly at the rear end 72 of the drive motor 3, without being able to flow along the circumferential side of the motor housing 106. Furthermore, the first partition wall 73 separates the first cooling-air duct 55 and the second cooling-air duct 58 from the outlet ducts 111, 113, 115.

The second partition wall 75 is arranged on the circumferential side of the motor housing 106 and extends in the radial direction of the rotational axis 8 of the drive motor 3. With respect to the direction of the rotational axis 8, the second partition wall 75 is arranged between the fan wheel 107 and the front end 71 of the drive motor 3. The third partition wall 79 is arranged on the circumferential side of the motor housing 106 and extends in the radial direction of the rotational axis 8 of the drive motor 3. With respect to the direction of the rotational axis 8, the third partition wall 79 is arranged between the second partition wall 75 and the front end 71 of the drive motor 3. The second partition wall 75 and the third partition wall 79 are formed in such a way that they separate the third cooling-air duct 61 and the fourth cooling-air duct 76 from the outlet ducts 111, 113, 115. Flow of the third cooling-air flow 63 and the fourth cooling-air flow 78 along the circumferential side of the motor housing 106 is thus prevented.

A fourth partition wall 110 extends substantially along the direction of the rotational axis 8 of the drive motor 3 and connects the second partition wall 75 and the third partition wall 79. The second partition wall 75 separates a section of an outlet duct which extends in the direction of the rotational axis 8 of the drive motor 3 from a cooling-air duct.

As shown in FIG. 5, the drive motor 3 is held on the circumferential side of the motor housing 106 by the first partition wall 73, the second partition wall 75, and the third partition wall 79.

The plurality of partition walls 73, 75, 79, 110 and the guide wall 66 are preferably formed from plastic. The plurality of partition walls 73, 75, 79, 110 and the guide wall 66 are formed in particular integrally with the housing 2. The plurality of partition walls 73, 75, 79, 110 may at least partially also be formed from an elastic plastic, whereby installation-space regions can be sealed off from one another in an air-tight manner in a simple way.

As shown in FIGS. 2 to 4, the motor section 88 of the housing 2 comprises an underside 117 oriented toward the handle housing 87. Via the underside 117, the first longitudinal side 17 and the second longitudinal side 18 of the housing 2 are connected to one another. The first cooling-air inlet 56 and the second cooling-air inlet 59 are arranged on the underside 117 of the motor section 88. The first cooling-air inlet 56 is arranged above the second cooling-air inlet 59. The third cooling-air inlet 62 is formed on the first longitudinal side 17 of the housing 2. The third cooling-air inlet 62 is formed between the central section 89 and the motor section 88 of the housing 2. The fourth cooling-air inlet 77 is formed on the second longitudinal side 18 of the housing 2. The fourth cooling-air inlet 77 is formed in particular between the central section 89 and the motor section 88 of the housing 2. The first outlet 112 of the first outlet duct 111 is formed on the second longitudinal side 18 of the housing 2. The first outlet 112 is arranged in the central section 89 of the housing 2. The second outlet 114 of the second outlet duct 113 is arranged in particular on the second longitudinal side 18 of the housing 2. The second outlet 114 is arranged in particular in the motor section 88 of the housing 2. In the direction of the longitudinal center axis 5 of the guide bar 4, the fourth cooling-air inlet 77 is arranged between the first outlet 112 and the second outlet 114, in particular centrally between the first outlet 112 and the second outlet 114. The first outlet 112 lies in front of the fourth cooling-air inlet 77, the second outlet 114 lies behind the fourth cooling-air inlet 77. The third outlet 116 of the third outlet duct 115 is formed on the first longitudinal side 17 of the housing 2. The third outlet 116 is arranged in particular in the motor section 88 of the housing 2, in particular directly adjacent to the underside 117 of the motor section 88 of the housing 2. The cooling-air inlets 56, 59, 62, 77 and the outlets 112, 114, 116 are arranged on the housing 2 of the work apparatus 1 at such a distance from one another that no warmed-up air discharged from the outlets 112, 114, 116 of the work apparatus 1 is drawn in as cooling air through the cooling-air inlets 56, 59, 62, 77. Thus, efficient cooling of the work apparatus 1 can be ensured.

As shown in FIGS. 5 and 6, the control board 52 is free from a potting compound. Conventional control boards are often provided with a potting compound for protecting the electronic components arranged on the control board 52. The potting compound often consists of a resin. In the present embodiment of the work apparatus 1, the control board 52 is in particular completely free from a potting compound. As a result, the heat generated at the control board 52 can be removed directly by the cooling-air flows 57, 60. Storage of heat in the potting compound is avoided.

As shown in particular in FIG. 8, the work apparatus 1 comprises a tensioning device 20. The tensioning device 20 is configured to tension the saw chain 6. In a released state of the fixing device 15, the guide bar 4 is displaceable relative to the housing 2 in the direction of its longitudinal center axis 5. In this state of the fixing device 15, the tensioning device 20 can act on the guide bar 4 in such a way that the guide bar 4 is pushed forward, that is to say in the direction of the longitudinal center axis 5 of the guide bar 4 away from the front end 82 of the housing 2. In this case, the saw chain 6, which rests on the guide bar 4, is tensioned.

As shown in FIG. 8, the tensioning device 20 comprises a pivotably mounted tensioning lever 21. The tensioning lever 21 is pivotable in particular in a first pivoting direction 31 and in a second pivoting direction 32 opposite to the first pivoting direction 31. The tensioning lever 21 is pivotable in particular about a pivot axis 37 (FIGS. 10 and 11). The pivot axis 37 lies in a plane which is arranged parallel to the longitudinal plane 80 of the guide bar 4. The pivot axis 37 is oriented in particular perpendicular to the transverse plane 81. The tensioning lever 21 is operatively connected to the guide bar 4 in such a way that, upon a pivoting movement of the tensioning lever 21 in the first pivoting direction 31, the guide bar 4 is movable by the tensioning lever 21 in the direction of the longitudinal center axis 5 of the guide bar 4 for tensioning the saw chain 6. The tensioning lever 21 is particularly preferably operatively connected directly to the guide bar 4.

As shown in FIGS. 8, 10, and 11, the tensioning lever 21 comprises a lever head 23. The lever head 23 is provided in particular for contact with the guide bar 4. An opening 9 is formed in the guide bar 4. The lever head 23 engages in the opening 9 of the guide bar 4 and pushes the guide bar 4 forward, whereby the saw chain 6 is tensioned. As shown in particular in FIG. 8, the tensioning device 20 comprises a spring unit 22. The spring unit 22 biases the tensioning lever 21 in the first pivoting direction 31. Thus, the tensioning lever 21, biased by the spring unit 22 in the first pivoting direction 31 against the guide bar 4, produces a pretensioning force on the saw chain 6.

The spring unit 22 is in particular a leg spring. The spring unit 22 comprises in particular a first leg 27, which is held on the tensioning lever 21. The spring unit 22 comprises in particular a second leg 28, by means of which the spring unit 22 is supported on the housing 2. The spring unit 22 is fastened in particular on the tensioning lever 21. For this purpose, the tensioning lever 21 comprises a boss 26 on which the spring unit 22 is arranged. The spring unit 22 surrounds the boss 26 with a plurality of turns, whereby the spring unit 22 is held firmly on the tensioning lever 21.

The spring unit 22 and the tensioning lever 21 are designed in such a way that they generate a tensioning force in the first pivoting direction 31 on the guide bar 4. The tensioning force is in particular at least 5 N. The tensioning force is at most 15 N, in particular at most 10 N. This tensioning-force range covers the range in which the saw chain 6 runs reliably on the guide bar 4 and the frictional forces between the saw chain 6 and the guide bar 4 are not too high.

The opening 9 is formed in particular as a slot, that is to say the opening 9 is open toward the rear end of the guide bar 4. Alternatively, it may also be provided that the opening 9 has a closed circumferential contour. The opening 9 extends parallel to the longitudinal center axis 5 of the guide bar 4. The opening 9 is arranged in the guide bar 4 in such a way centrally that the longitudinal center axis 5 of the guide bar 4 also forms the longitudinal center axis of the opening 9. The opening 9 comprises a front end face 120, an upper side 121, and an underside 122, the upper side 121 and the underside 122 being connected to one another via the end face 120.

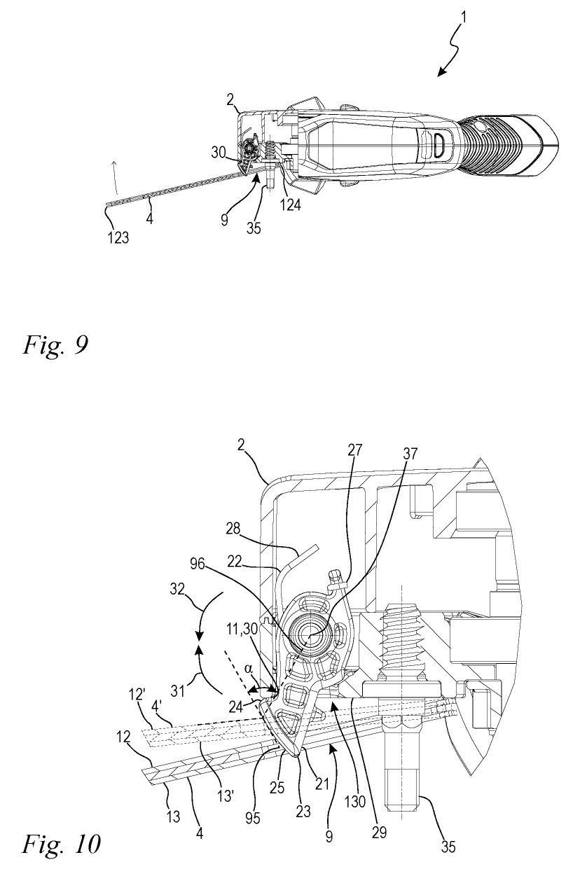

FIG. 9 shows how the guide bar 4 is mounted on the housing 2 of the work apparatus 1. First, the saw chain 6 is placed around the drive sprocket 7 and around the guide bar 4. The drive sprocket 7 and the saw chain 6 are not illustrated in more detail in this figure. The guide bar 4 comprises a front end 123 which faces away from the housing 2 of the work apparatus 1. The guide bar 4 comprises a rear end 124 which faces toward the housing 2 of the work apparatus 1. The guide bar 4 is threaded onto the stud 35 so that the stud 35 projects through the opening 9 of the guide bar 4. The rear end 124 of the guide bar 4 is in this case arranged very close to a contact surface 29 of the housing 2. The contact surface 29 is the surface of the housing 2 against which the guide bar 4, in particular the first longitudinal side 12 of the guide bar 4, is clamped by means of the fixing device 15. It may also be provided that the rear end 124 of the guide bar 4 lies directly against the contact surface 29 of the housing 2. Subsequently, the guide bar 4 is pivoted into contact with the contact surface 29 of the housing 2.

If the guide bar 4 is not yet mounted on the housing 2, the tensioning lever 21 is biased against the housing 2, in particular against a front housing stop 30. The biasing against the front housing stop 30 is effected by the spring force of the spring unit 22. During pivoting-in of the guide bar 4 for mounting, the tensioning lever 21 engages in the opening 9 of the guide bar 4. The opening 9 and the tensioning lever 21 are designed in such a way that the tensioning lever 21 contacts the guide bar 4 before the guide bar 4 can be brought, with its first longitudinal side 12, into contact with the contact surface 29. This contact between the guide bar 4 and the tensioning lever 21 is illustrated in FIG. 10 by the guide bar 4 shown in dashed lines.

As shown in FIG. 10, the tensioning lever 21 projects into the opening 9 of the guide bar 4 during pivoting-in of the guide bar 4 toward the contact surface 29 of the housing 2. In this case, the guide bar 4 comes into contact with the lever head 23 of the tensioning lever 21. The lever head 23 of the tensioning lever 21 comes into contact in particular with the front end face 120 of the opening 9 of the guide bar 4. The tensioning lever 21 comprises in particular a guide surface 25. The guide surface 25 is formed on the lever head 23 of the tensioning lever 21. The guide surface 25 is configured for contact with the guide bar 4. Via the guide surface 25 of the tensioning lever 21, in particular of the lever head 23 of the tensioning lever 21, the tensioning lever 21 contacts the guide bar 4 during pivoting-in of the guide bar 4. If the operator presses the guide bar 4, after first contact with the tensioning lever 21, further in the direction toward the contact surface 29 of the housing 2, the tensioning lever 21 is pushed back by the guide bar 4, whereby the tensioning lever 21 pivots back in the second pivoting direction 32 against the spring force of the spring unit 22.

As shown in FIG. 10, the guide surface 25 of the tensioning lever 21, in particular of the lever head 23 of the tensioning lever 21, is formed with a convex curvature. The guide surface 25 of the tensioning lever 21 is configured in particular in such a way that the tensioning lever 21 is pivoted in the second pivoting direction 32 solely by the restoring force of the guide bar 4. Additional manual intervention, for example by pulling back the tensioning lever 21, is not required. Consequently, the guide surface 25 of the tensioning lever 21 is configured in such a way that the guide surface 25 of the tensioning lever 21 and the front end face 120 of the guide bar 4 are free from self-locking when in mutual contact. In other words, the tensioning lever 21 slides, via its guide surface 25, along the front end face 120 of the opening 9 of the guide bar 4 and pivots back in the second pivoting direction 32.

As shown in FIG. 10, the guide bar 4 comprises a first longitudinal side 12 which faces the housing 2, in particular the contact surface 29 of the housing 2. The guide bar 4 comprises in particular a second longitudinal side 13 which faces away from the contact surface 29 of the housing 2. During pivoting-in of the guide bar 4 toward the contact surface 29 of the housing 2, the guide bar 4 contacts the tensioning lever 21 with its first longitudinal side 12. At this contact point, a tangential plane 95 and a connecting line 96 enclose an engagement angle α. The tangential plane 95 contacts the guide surface 25 of the tensioning lever 21 at the contact point of the guide surface 25 of the tensioning lever 21 and the guide bar 4. The connecting line 96 is oriented in such a way that it intersects the pivot axis 37 of the tensioning lever 21 and the contact point. The engagement angle α relates to a viewing direction toward the pivot axis 37. The engagement angle α is at most 70°, in particular at most 60°, in particular approximately 56°. The smaller the engagement angle α is, the lower is the tendency toward self-locking between the guide bar 4 and the tensioning lever 21. The guide surface 25 of the tensioning lever 21 is configured in such a way that the resulting engagement angle α lies in a range which excludes self-locking of the contact pairing. The guide surface 25 is formed, in a view in the direction of the pivot axis 37, in the form of a spiral, in particular a logarithmic spiral, about the pivot axis 37. As a result, the engagement angle α is approximately constant over the entire guide surface 25 of the tensioning lever 21.

In order to improve sliding of the guide surface 25 of the tensioning lever 21 and of the guide bar 4, at least one chamfer 10 is formed at the opening 9 of the guide bar 4, as shown in FIG. 18. The at least one chamfer 10 is formed at the front end face 120 of the opening 9 of the guide bar 4. In the present case, a chamfer 10 is formed starting from the front end face 120 toward the first longitudinal side 12 and a further chamfer, which is not illustrated in detail, is formed toward the second longitudinal side 13. This ensures a symmetrical configuration of the guide bar 4, whereby the guide bar 4 can be mounted in two installation positions. Undercuts are provided at the corners of the front end face 120 for reducing stress. The chamfer angle of the at least one chamfer 10 is preferably from 40° to 55°. The chamfer angle of the at least one chamfer 10 is particularly preferably 45°. In an alternative embodiment, instead of a chamfer 10, a radius may also be provided to avoid self-locking between the tensioning lever 21 and the guide bar 4.

In FIG. 11, the guide bar 4 lies, with its first longitudinal side 12, against the contact surface 29 of the housing 2. The guide bar 4 is mounted. The tensioning lever 21 passes, with its lever head 23, through the opening 9 of the guide bar 4. The lever head 23 is pressed, by the spring unit 22, against the guide bar 4, in particular against the front end face 120 of the opening 9 of the guide bar 4. In this case, the guide bar 4 tensions the saw chain 6, which is not illustrated in greater detail in FIG. 11. In this state of the tensioning device 20, the tensioning lever 21 does not contact the housing stop 30 with its lever head 23. This ensures that the tensioning force of the spring unit 22 can be transmitted via the tensioning lever 21 also onto the saw chain 6.

Finally, the sprocket cover 16 is to be mounted. The sprocket cover 16 is screwed onto the stud 35 by means of the nut 34 until the sprocket cover 16 rests against the second longitudinal side 13 of the guide bar 4. If the fixing device 15 in the form of the sprocket cover 16 is fixed, the guide bar 4 is clamped between the sprocket cover 16 and the contact surface 29 of the housing 2 in order to prevent displacement in the longitudinal direction of the guide bar 4. In order to retension the saw chain 6, it is already sufficient to loosen the nut 34 of the sprocket cover 16 so that the clamping action of the sprocket cover 16 and the housing 2 on the guide bar 4 is cancelled. The tensioning lever 21 then pushes the guide bar 4 forward and tensions the saw chain 6. Subsequently, the nut 34 of the sprocket cover 16 can be tightened again.

If the sprocket cover 16, which is part of the housing 2, is mounted, the tensioning device 20 is completely enclosed by the housing 2 and is thus not accessible to the operator. If the sprocket cover 16 is removed, the operator has access to the tensioning lever 21.

As shown in FIG. 10, the lever head 23 comprises a lug 24. If the guide bar 4 is not mounted, the lever head 23 is biased, via the spring unit 22, against the front housing stop 30. The lug 24 of the lever head 23 is formed in such a way that it grips around the front housing stop 30. Thus, the lever head 23 is held on the front housing stop 30, whereby the mounting of the tensioning lever 21 with the spring unit 22 is also simplified. The housing stop 30 thus forms a retaining contour 11 for fastening the tensioning lever 21 to the housing 2 of the work apparatus 1. The lug 24 of the lever head 23 grips around the front housing stop 30, whereby a form-fitting connection between the tensioning lever 21 and the housing 2 in a direction transverse to the longitudinal plane 80 of the work apparatus 1 is formed.

As shown in FIG. 11, the housing 2 comprises a first housing half 125 and a second housing half 126. The contact surface 29 for contact of the guide bar 4 is formed on the second housing half 126. The pivot axis 37 of the tensioning lever 21 lies in particular in the second housing half 126. The first housing half 125 and the second housing half 126 form a first receiving space 127. In this first receiving space 127, a drive unit, comprising in particular the drive motor 3 and a gear unit, is arranged. The first housing half 125 and the second housing half 126 form at least one second receiving space 128. The tensioning device 20 is arranged in particular in the second receiving space 128. The first receiving space 127 and the second receiving space 128 are separated in particular from one another by a partition wall 129. By the separate configuration of the first receiving space 127 and the second receiving space 128 and their separation from one another by the partition wall 129, it can be avoided that contamination which enters the second receiving space 128 is also transferred into the first receiving space 127. A passage opening 130 is provided in the second receiving space 128, through which the tensioning lever 21 projects from the second receiving space 128 through the opening 9 of the guide bar 4. Contamination could enter the second receiving space 128 via the passage opening 130, for example.

As shown in FIG. 11, the contours of the tensioning lever 21 and the housing 2, in particular the second housing half 126, are matched to one another in such a way that, downstream of the passage opening 130, they form a type of labyrinth seal. The tensioning lever 21 comprises a rear region 38 facing away from the lug 24 of the tensioning lever 21. A sealing projection 39 is formed on the rear region 38 of the tensioning lever 21. The sealing projection 39 of the tensioning lever 21 is formed in such a way that the space between the housing 2 and the tensioning lever 21 in the passage opening 130 is minimized. A gap 19, which is part of the labyrinth seal, is formed between the sealing projection 39 and the housing 2. Furthermore, the sealing projection 39 of the tensioning lever 21 is formed in such a way that the width of the gap 19 remains constant during pivoting of the tensioning lever 21. This prevents contamination from entering the second receiving space 128 via the passage opening 130. Alternatively, it may also be provided that the first receiving space 127 and the second receiving space 128 are formed as a single receiving space connected to one another.

As shown in FIG. 11, the tensioning lever 21 is arranged between the front end 82 of the housing 2 and the stud 35. The second receiving space 128 is arranged between the front end 82 of the housing 2 and the first receiving space 127.

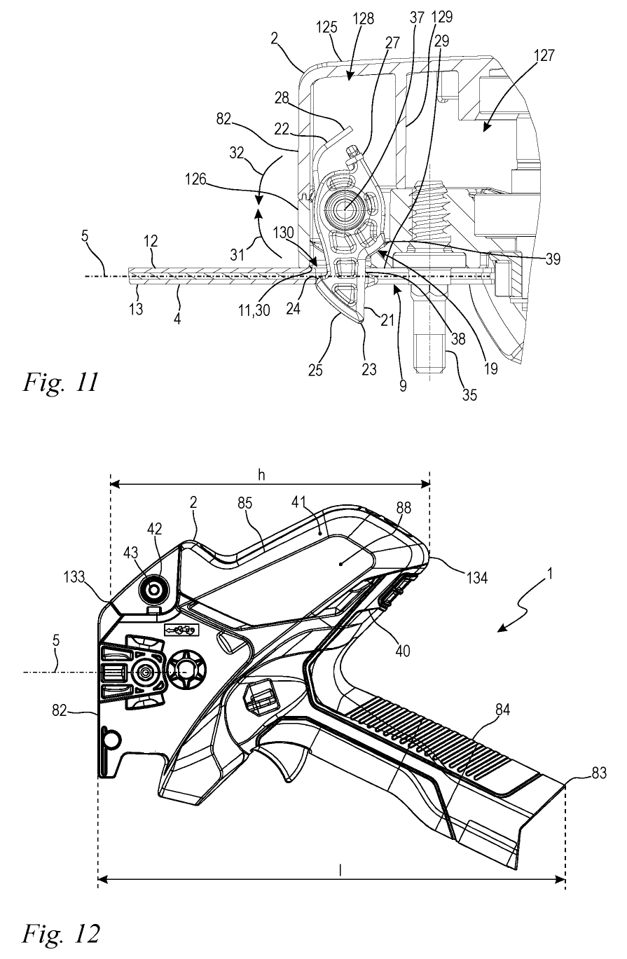

In FIG. 12, the portable work apparatus is shown in a side view without a guide bar 4 and without a sprocket cover 16. The housing 2 comprises a housing main body 40. The housing main body 40 comprises in particular a plurality of sections, in particular the handle housing 87, the motor section 88, and the central section 89. Furthermore, the work apparatus 1 comprises a cover 41. The cover 41 is configured for at least partially covering the housing main body 40.

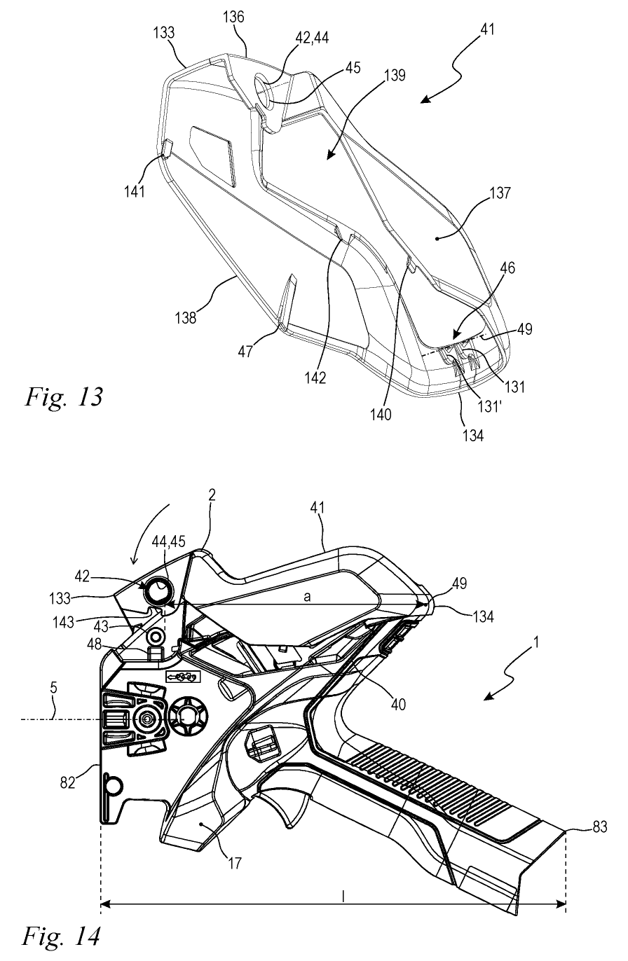

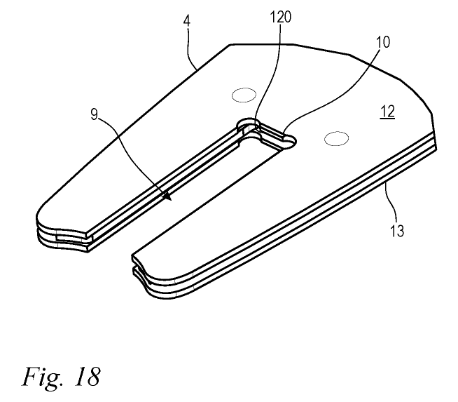

In FIG. 13, the cover 41 is shown. The cover 41 is configured as a hood. The cover 41 serves in particular for partially covering the motor section 88 of the housing 2. Furthermore, the cover 41 at least partially forms the second handle 85 of the work apparatus 1. The cover 41 is configured to be elastically deformable. The cover 41 consists of a plastic, in particular an elastically deformable plastic. A fastening contour 42 is provided, in particular formed, on the cover 41. As shown in particular in FIGS. 14 and 17, the housing main body 40 comprises a mating contour 43. The mating contour 43 is formed in particular on the housing main body 40. The fastening contour 42 of the cover 41 and the mating contour 43 of the housing main body 40 are formed in such a way that they form a form-fitting connection between the cover 41 and the housing main body 40. Furthermore, the cover 41 is formed in such a way that, for fastening on the housing main body 40, it must be elastically deformed in order to bring the fastening contour 42 of the cover 41 into operative engagement with the mating contour 43 of the housing main body 40. If the fastening contour 42 of the cover 41 and the mating contour 43 of the housing main body 40 are in operative engagement, a form-fit is present. If the cover 41 is mounted on the housing main body 40, that is to say if the fastening contour 42 and the mating contour 43 form a form-fitting connection, the cover 41 is undeformed.

As shown in FIG. 13, the fastening contour 42 of the cover 41 is a retaining opening 44 formed on the cover 41. The retaining opening 44 is formed here as circular. The retaining opening 44 is in particular a through-opening. The retaining opening 44 has in particular a closed opening contour 45. Due to the closed configuration of the retaining opening 44, the fastening contour 42 has a high strength in comparison with, for example, a slotted contour.

As shown in particular in FIG. 17, the mating contour 43 is formed as a projection on the housing main body 40. If the cover 41 is mounted, in particular fastened, on the housing main body 40, the retaining opening 44 of the cover 41 surrounds the mating contour 43 of the housing main body 40, which is formed as a projection. In other words, the mating contour 43 formed as a projection projects into the retaining opening 44 and in particular passes through the retaining opening 44. The mating contour 43, in particular the projection, is connected in particular integrally to the housing main body 40. The housing main body 40 is preferably composed of plastic, in particular of PA6-GF30-I.

As shown in FIG. 13, the cover 41 comprises at least one hinge element 46. By way of the hinge element 46, the cover 41 can be pivoted about an axis of rotation 49 relative to the housing main body 40. The connection between the housing main body 40 and the cover 41 provided by the hinge element 46 can be produced and/or released without tools. The hinge element 46 is configured in particular in such a way that, during assembly of the work apparatus 1, the cover 41 is supported on the housing main body 40 via the hinge element 46, and that the hinge element 46 permits a pivoting movement of the cover 41 about the axis of rotation 49 onto the housing main body 40. In this case, the cover 41 can be pivoted into a position fastened on the housing main body 40.

As shown in FIGS. 13 and 16, the hinge element 46 is formed in particular from at least one gripping hook 131, 131' and at least one retaining element 132, the gripping hook 131, 131' at least partially engaging around the retaining element 132 when the cover 41 is fastened on the housing main body 40. The at least one gripping hook 131, 131' is formed here on the cover 41. The at least one retaining element 132 is formed in particular on the housing main body 40 of the housing 2. Here, two gripping hooks 131, 131' are formed in particular on the cover 41, which gripping hooks form part of the hinge element 46. In the preferred embodiment, the two gripping hooks 131, 131' are an integral part of the cover 41. The at least one retaining element 132 is in particular an integral part of the housing main body 40.

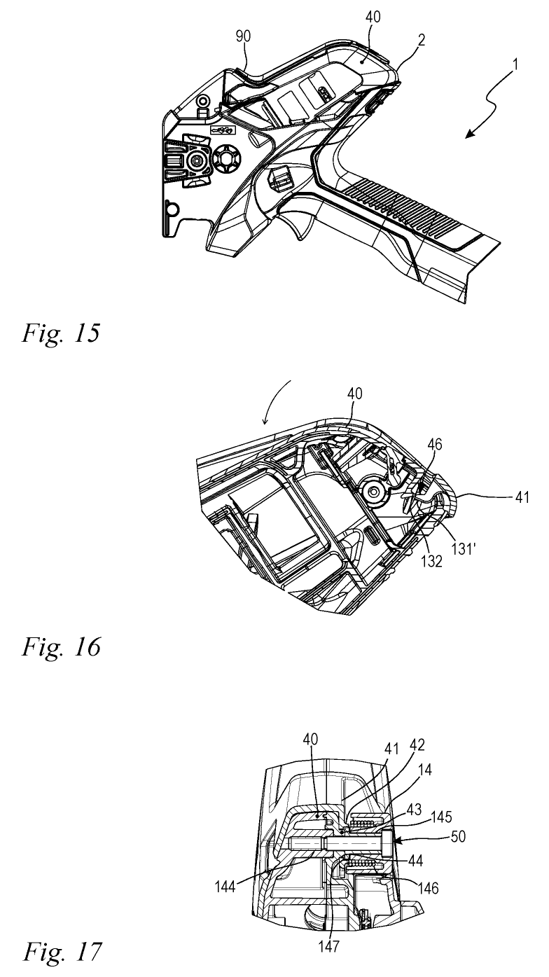

As shown in FIG. 12, the cover 41 extends from a front end 133 to a rear end 134. At the rear end 134, parts of the hinge element 46, in particular the two gripping hooks 131, 131', are formed. In the region of the front end 133, the fastening contour 42 is formed in particular. As already described above, the cover 41 is configured as a hood. The cover 41 therefore comprises an upper side 136, a first longitudinal side 137, and a second longitudinal side 138. The first longitudinal side 137 and the second longitudinal side 138 of the cover 41 are connected to one another via the upper side 136 of the cover 41. The first longitudinal side 137, the second longitudinal side 138, and the upper side 136 of the cover 41 extend in particular from the rear end 134 to the front end 133 of the cover 41. An opening 139 is formed on the upper side 136, in which a grip surface 90 of the second handle 85 is arranged in particular. The grip surface 90 is formed on the housing main body 40 (FIG. 15). The upper side 136 of the cover 41 forms at least partially an upper side of the work apparatus 1, in particular an upper side 118 of the motor section 88 of the housing 2. The first longitudinal side 137 of the cover 41 forms at least partially, in particular, the first longitudinal side 17 of the housing 2 of the work apparatus 1. The second longitudinal side 138 of the cover 41 forms at least partially, in particular, the second longitudinal side 18 of the housing 2 of the work apparatus 1.

As shown in FIG. 14, the axis of rotation 49 of the hinge element 46 and the mating contour 43 of the housing main body 40, in the fastened state of the cover 41, have a distance a measured in the direction of the longitudinal center axis 5. The housing 2 of the work apparatus 1 has an overall length l. The overall length l of the housing 2 of the work apparatus 1 corresponds in particular to the distance, measured in the direction of the longitudinal center axis 5 of the guide bar 4, between the front end and the rear end of the housing 2. The distance a between the axis of rotation 49 of the hinge element 46 and the mating contour 43 corresponds in particular to at least 20%, in particular at least 30%, of the overall length l of the housing 2 of the work apparatus 1.

As shown in FIG. 12, the cover 41 has a length h. The length h of the cover 41 corresponds to the distance between the front end 133 and the rear end 134 of the cover 41. The distance h is measured, in the fastened state of the cover 41, in the direction of the longitudinal center axis 5 of the guide bar 4. The length h of the cover 41 corresponds to at least 30%, in particular at least 40%, of the overall length l of the housing 2.

As shown in FIG. 13, at least one first insertion element 47, in particular at least one first insertion rib, is formed on the cover 41. The at least one first insertion element 47 of the cover 41 engages into the housing main body 40, whereby the cover 41 is fixed to the housing main body 40 by means of the at least one first insertion element 47. The at least one first insertion element 47 is formed in particular on the second longitudinal side 138 of the cover 41, in particular on the lower edge of the second longitudinal side 138 of the cover 41. The at least one first insertion element 47 is arranged approximately centrally between the front end 133 and the rear end 134 of the cover 41. Furthermore, a second insertion element 140 is provided on the cover 41. The second insertion element 140 is arranged on the first longitudinal side 137 of the cover 41 opposite the first insertion element 47. The second insertion element 140 is arranged in particular at the lower edge of the first longitudinal side 137 of the cover 41.

As shown in FIG. 13, a third insertion element 141 is arranged, in particular formed, on the cover 41. The third insertion element 141 is arranged in particular on the second longitudinal side 138 of the cover 41 in the region of the front end 133 of the cover 41. In addition, the third insertion element 141 is arranged at the lower edge of the second longitudinal side 138 of the cover 41.

As shown in FIG. 13, the fastening contour 42 of the cover 41 is formed in particular on the first longitudinal side 137, in particular on the first longitudinal side 137 in the region of the front end 133 of the cover 41. The third insertion element 141 is formed in particular on the second longitudinal side 138 of the cover 41 opposite the fastening contour 42.

As shown in FIG. 13, a fourth insertion element 142 is formed in particular on the cover 41. The fourth insertion element 142 is formed in particular on the second longitudinal side 138 of the cover 41, in particular on an upper edge of the second longitudinal side 138 of the cover 41. The fourth insertion element 142 is arranged in particular centrally between the front end 133 and the rear end 134 of the cover 41. Preferably, analogously to the fourth insertion element 142, a fifth insertion element, which is arranged opposite the fourth insertion element 142, is provided on the first longitudinal side 137.

All insertion elements serve for fixing the cover 41 to the housing main body 40. All insertion elements are preferably formed integrally on the cover 41. All insertion elements may be configured as insertion ribs, although other geometric configurations may also be expedient.

The cover 41 can in particular be fastened to the housing main body 40 without tools and/or be released from the housing main body 40 without tools.

As shown in FIG. 14, the housing main body 40 comprises an auxiliary pocket 48, which serves for reaching beneath the cover 41. The auxiliary pocket 48 is formed as a recess in the housing main body 40. The auxiliary pocket 48 is arranged in particular directly below the mating contour 43. A recess 143 is formed on the cover 41 in particular below the fastening contour 42. In the fastened position of the cover 41 on the housing main body 40, the auxiliary pocket 48 can be reached through the recess 143, so that the cover 41 can be reached beneath at the recess 143. If the operator reaches beneath the cover 41 in the region of the auxiliary pocket 48, the operator can pull or lever the cover 41, in particular the first longitudinal side 137 of the cover 41, away from the housing main body 40. In this case, the operator can cancel the form-fitting connection between the fastening contour 42 and the mating contour 43 and pivot the cover 41 away from the housing main body 40. The operator can either grip into the auxiliary pocket 48 with the fingers or with a tool, for example with a screwdriver, and lever the cover 41 off.

As shown in particular in FIGS. 1 and 2, the work apparatus 1 comprises in particular the tool cover 14. Furthermore, the work apparatus 1 comprises a fastening unit 50 by means of which the tool cover 14 is held on the housing main body 40, in particular pivotably (FIG. 17). The fastening unit 50 at the same time holds the cover 41 on the housing main body 40. The fastening unit 50 comprises a screw 144 which is screwed into the housing main body 40. A sleeve 145 is fastened on the screw 144. The tool cover 14 is mounted pivotably on the sleeve 145 and biased by means of a spring into a closed position of the tool cover 14. The screw 144 passes through both the fastening contour 42 of the cover 41, in particular the retaining opening 44 of the cover 41, and the mating contour 43 of the housing main body 40. The screw 144 clamps the sleeve 145 against the housing main body 40 via a sleeve shoulder 147. The cover 41 is not clamped, either directly or indirectly, by the screw 144. The cover 41 is configured to be free of contact with the sleeve shoulder 147 and the screw 144. The fastening unit 50 is configured in such a way that it merely blocks release of the cover 41 from the housing main body 40. Deformation of the cover 41 away from the housing main body 40 and pivoting of the cover 41 is merely spatially blocked by the fastening unit 50.

For mounting the cover 41 on the housing main body 40, the cover 41 is first placed, as shown in FIGS. 14 and 16, at its rear end 134 on the housing main body 40. Via the hinge element 46, the cover 41 is supported on the housing main body 40. The cover 41 can then be pivoted onto the housing main body 40 about the axis of rotation 49 of the hinge element 46. In this case, the cover 41 is deformed in such a way that it can be slipped over the mating contour 43 of the housing main body 40 until the fastening contour 42 of the cover 41 latches with the mating contour 43 of the housing main body 40 (FIG. 12). If the guide bar 4 is mounted, the tool cover 14 can be fastened via the fastening unit 50 and at the same time the cover 41 can be held on the housing main body 40 (FIG. 17).

What is claimed is:

1. A portable work apparatus, comprising:
a housing (2);
a drive motor (3) arranged in the housing (2);
a guide bar (4) having a longitudinal center axis (5) and a guide groove;
a saw chain (6) guided in the guide groove;
a drive sprocket (7) operatively connected to the drive motor (3) and configured to drive the saw chain (6) in circulation;
a fixing device (15) configured to fasten the guide bar (4) to the housing (2); and
a tensioning device (20) configured to tension the saw chain (6), the tensioning device (20) including a pivotably mounted tensioning lever (21),
wherein, in a released state of the fixing device (15), the guide bar (4) is displaceable relative to the housing (2) in a direction of the longitudinal center axis (5),
wherein, in a fixed state of the fixing device (15), the guide bar (4) is clamped to the housing (2), and
wherein the tensioning lever (21) is operatively connected to the guide bar (4) such that pivoting movement of the tensioning lever (21) in a first pivoting direction (31) moves the guide bar (4) in the direction of the longitudinal center axis (5) of the guide bar (4) to tension the saw chain (6).

2. The work apparatus according to claim 1,
wherein the tensioning lever (21) has a lever head (23) that engages in an opening (9) of the guide bar (4) and is configured to contact the guide bar (4), and
wherein a chamfer (10) is formed at the opening (9) of the guide bar (4).

3. The work apparatus according to claim 1,
wherein the tensioning lever (21) has a lug (24) configured to fasten the tensioning lever (21) to a retaining contour (11) of the work apparatus (1).

4. The work apparatus according to claim 1,
wherein the tensioning lever (21) has a convexly curved guide surface (25) via which the tensioning lever (21) contacts the guide bar (4) for mounting the guide bar (4).

5. The work apparatus according to claim 4,
wherein the guide surface (25) of the tensioning lever (21) is configured such that, when the guide bar (4) is pivoted toward the tensioning lever (21), the guide bar (4) rotates the tensioning lever (21) in a second pivoting direction (32) opposite the first pivoting direction (31).

6. The work apparatus according to claim 5,
wherein the guide surface (25) of the tensioning lever (21) is configured such that, at a contact point between the guide bar (4) and the guide surface (25), an engagement angle (α) is defined between a tangential plane (95) on the guide surface (25) and a connecting line (96) intersecting a pivot axis (37) of the tensioning lever (21) and the contact point, and
wherein the engagement angle (α) is at most 70°.

7. The work apparatus according to claim 2,
wherein, in a mounted position of the guide bar (4), the tensioning lever (21) projects through the opening (9) of the guide bar (4).

8. The work apparatus according to claim 1,
wherein the tensioning device (20) is enclosed by the housing (2) in a fully assembled state of the work apparatus (1),
wherein the work apparatus (1) has a sprocket cover (16) forming part of the housing (2), and
wherein the tensioning lever (21) of the tensioning device (20) is accessible to an operator when the sprocket cover (16) is removed.

9. A portable work apparatus (1), comprising:
a housing (2) including
a housing main body (40), and
a cover (41) configured to at least partially cover the housing main body (40); and
a drive motor (3) arranged in the housing (2) and configured to drive a tool (6) of the work apparatus (1),
wherein the cover (41) is configured as a hood, and
wherein the cover (41) has a fastening contour (42) configured to cooperate with a mating contour (43) formed on the housing main body (40) to form a form-fitting connection between the cover (41) and the housing main body (40), and
wherein the cover (41) is elastically deformable such that, during assembly of the work apparatus (1), deformation of the cover (41) closes the form-fitting connection between the fastening contour (42) and the mating contour (43).

10. The work apparatus according to claim 9,
wherein, in an assembled state of the work apparatus (1), the cover (41) is undeformed.

11. The work apparatus according to claim 9,
wherein the fastening contour (42) of the cover (41) is a retaining opening (44) formed in the cover (41), and
wherein the retaining opening (44) has a closed opening contour (45).

12. The work apparatus according to claim 9,
wherein the cover (41) includes at least one hinge element (46) configured to support the cover (41) on the housing main body (40) during assembly of the work apparatus (1) and to permit the cover (41) to pivot toward the housing main body (40), about an axis of rotation, into a fastened position.

13. The work apparatus according to claim 9, further comprising:
a tool cover (14); and
a fastening unit (50) configured to fasten the tool cover (14),
wherein the cover (41) is secured by the fastening unit (50).

14. A portable work apparatus (1), comprising:
a housing (2);
a drive motor (3) arranged in the housing (2) and configured to drive a tool (6) of the work apparatus (1);
a control unit (51) configured to control the drive motor (3), the control unit (51) including a control board (52) having a front side (53) and a rear side (54);
a first cooling-air duct (55) having a first cooling-air inlet (56) formed on the housing (2), the first cooling-air duct (55) configured to guide a first cooling-air flow (57); and
a second cooling-air duct (58) having a second cooling-air inlet (59) formed on the housing (2), the second cooling-air duct (58) configured to guide a second cooling-air flow (60),
wherein the rear side (54) of the control board (52) is part of an inner wall (64) of the first cooling-air duct (55), and
wherein the front side (53) of the control board (52) is part of an inner wall (65) of the second cooling-air duct (58), and
wherein the control board (52) is arranged in a region of the first cooling-air inlet (56) and the second cooling-air inlet (59) such that the rear side (54) of the control board (52) is directly impinged upon by the first cooling-air flow (57) immediately after the first cooling-air flow (57) enters the first cooling-air duct (55), and
wherein the front side (53) of the control board (52) is directly impinged upon by the second cooling-air flow (60) immediately after the second cooling-air flow (60) enters the second cooling-air duct (58).

15. The work apparatus according to claim 14, further comprising:
a guide wall (66) configured to guide the first cooling-air flow (57) and the second cooling-air flow (60) from the respective cooling-air inlets (56, 59) to the control board (52).

16. The work apparatus according to claim 15,
wherein the control board (52) is held on the guide wall (66) adjacent to the drive motor (3).

17. The work apparatus according to claim 14,
wherein the first cooling-air inlet (56) and the second cooling-air inlet (59) are arranged adjacent to one another.

18. The work apparatus according to claim 14,
wherein the first cooling-air duct (55) extends from the first cooling-air inlet (56), over the rear side (54) of the control board (52), over the front side (53) of the control board (52), and toward the drive motor (3).

19. The work apparatus according to claim 14,
wherein the control board (52) extends from a first end (67) facing at least one of the first cooling-air inlet (56) and the second cooling-air inlet (59) to a second end (68), and
wherein a first air-guiding element (69) is arranged adjacent to the second end (68) of the control board (52), the first air-guiding element (69) being configured to deflect the first cooling-air flow (57) from the rear side (54) of the control board (52) to the front side (53) of the control board (52).

20. The work apparatus according to claim 14,
wherein the second cooling-air duct (58) extends from the second cooling-air inlet (59) over the front side (53) of the control board (52) directly toward the drive motor (3).
